(19) United States
(12) Patent Application Publication
(10) Pub. No.: US 2021/0051502 A1
(43) Pub. Date: Feb. 18, 2021

(54) BASE STATION APPARATUS, TERMINAL APPARATUS, AND COMMUNICATION METHOD

(71) Applicant: SHARP KABUSHIKI KAISHA, Sakai City, Osaka (JP)

(72) Inventors: RYOTA YAMADA, Sakai City (JP); HIROMICHI TOMEBA, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/071,227

(22) PCT Filed: Jan. 24, 2017
(86) PCT No.: PCT/JP2017/002360

§ 371 Date: Jul. 19, 2018

(30) Foreign Application Priority Data
Jan. 26, 2016 (JP) 2016-012181

(51) Int. Cl. H04W 24/10; H04W 16/28; H04W 72/04; H04L 5/00

(52) U.S. Cl. CPC H04W 24/10; H04L 5/0048; H04W 72/042; H04W 16/28

(57) ABSTRACT

Provided are a base station apparatus, a terminal apparatus, and a communication method, capable of enhancing throughput in a case of performing beamforming. A transmitter configured to transmit a measurement configuration as configuration information of measurement performed by the terminal apparatus, and a receiver configured to receive a measurement report from the terminal apparatus are included, the measurement configuration includes a report configuration, and a measuring beam list, the report configuration includes a configuration indicating a periodic reporting or an event-based reporting, and the measuring beam includes a cell identity and a beam identity.

### TECHNICAL FIELD

The present invention relates to a base station apparatus, a terminal apparatus, and a communication method.

### BACKGROUND ART

In a communication system such as Long Term Evolution (LTE) or LTE-Advanced (LTE-A) standardized by the Third Generation Partnership Project (3GPP), the communication area can be widened by taking a cellular configuration in which areas covered by base station apparatuses (base stations, transmission stations, transmission points, downlink transmission devices, uplink reception devices, a group of transmit antennas, a group of transmit antenna ports, component carriers, eNodeB) or transmission stations equivalent to the base station apparatuses are arranged in the form of multiple cells (Cells) being linked together. In such a cellular configuration, frequency efficiency can be improved by using the same frequency among neighboring cells or sectors.

In recent years, a next generation mobile communication system has been studied. In the next generation mobile communication system, communication in a high-frequency band in which a wideband for more large-capacity transmission can be secured is focused. The next generation mobile communication system is described in NPL 1.

### CITATION LIST

### Non Patent Document

[NON PATENT DOCUMENT 1] NPL 1: ARIB 2020 and Beyond Ad Hoc Group, White Paper, “Mobile Communications Systems for 2020 and beyond”, version 1.0.0, October, 2014.

### DISCLOSURE OF THE INVENTION

### Problems to be Solved by the Invention

However, a communication distance in the communication in a high-frequency band decreases, thus securing a coverage becomes a problem. Although beamforming as a technique for securing a coverage is effective, there is a problem that a base station apparatus needs to perform suited beamforming for a terminal apparatus.

The present invention has been made in consideration of the above circumstances, and an object of the invention is to provide a base station apparatus, a terminal apparatus, and a communication method, capable of enhancing throughput in a case of performing the beamforming.

### Means for Solving the Problems

To address the above-mentioned drawbacks, a base station apparatus, a terminal apparatus, and a communication method according to an aspect of the present invention are configured as follows.

A base station apparatus according to an aspect of the present invention is a base station apparatus configured to communicate with a terminal apparatus, the base station apparatus including, a transmitter configured to transmit a measurement configuration as configuration information of measurement performed by the terminal apparatus, and a receiver configured to receive a measurement report from the terminal apparatus, in which the measurement configuration includes a report configuration, and a measuring beam list, the report configuration includes a configuration indicating a periodic reporting or an event-based reporting, and the measuring beam includes a cell identity and a beam identity.

In a base station apparatus according to an aspect of the present invention, in a case of the event-based reporting, the report configuration includes an event ID and a threshold, and the event ID indicates a case in which a measurement result of a serving beam as a beam to which the terminal apparatus connects becomes better than the threshold.

In a base station apparatus according to an aspect of the present invention, in the case of the event-based reporting, the report configuration includes an event ID and a threshold, and the event ID indicates a case in which a measurement result of a serving beam as a beam to which the terminal apparatus connects becomes worse than the threshold.

In a base station apparatus according to an aspect of the present invention, in the case of the event-based reporting, the report configuration includes an event ID and a threshold, and the event ID indicates a case in which a measurement result of a beam different from a serving beam as a beam to which the terminal apparatus connects becomes better than the threshold.

In a base station apparatus according to an aspect of the present invention, the measurement report includes a measurement result of a serving beam as a beam to which the terminal apparatus connects and/or a measurement result of a beam other than the serving beam.

In a base station apparatus according to an aspect of the present invention, a measurement result of the serving beam includes reception power or reception quality, and a measurement result of a beam other than the serving beam includes a cell identity and a beam identity, reception power or reception quality.

In a base station apparatus according to an aspect of the present invention, the reception power or reception quality is calculated from a channel state information reference signal.

A base station apparatus according to an aspect of the present invention is a terminal apparatus configured to communicate with a base station apparatus, the terminal apparatus including, a receiver configured to receive a measurement configuration as configuration information of measurement from the base station apparatus, and a transmitter configured to transmit a measurement report to the base station apparatus, in which the measurement configuration includes a report configuration, and a measuring beam list, the report configuration includes a configuration indicating a periodic reporting or an event-based reporting, and the measuring beam includes a cell identity and a beam identity.

In a terminal apparatus according to an aspect of the present invention, in the case of the event-based reporting, the report configuration includes an event ID and a threshold, and the event ID indicates a case in which a measurement result of a serving beam as a beam to which the terminal apparatus connects becomes better than the threshold.

In a terminal apparatus according to an aspect of the present invention, in the case of the event-based reporting, the report configuration includes an event ID and a threshold, and the event ID indicates a case in which a measurement result of a serving beam as a connecting beam becomes worse than the threshold.

In a terminal apparatus according to an aspect of the present invention, in the case of the event-based reporting, the report configuration includes an event ID and a threshold, and the event ID indicates a case in which a measurement result of a serving beam as a connecting beam becomes worse than the threshold.

In a terminal apparatus according to an aspect of the present invention, the measurement report includes a measurement result of a serving beam as a connecting beam and/or a measurement result of a beam other than the serving beam.

In a terminal apparatus according to an aspect of the present invention, a measurement result of the serving beam includes reception power or reception quality, and a measurement result of a beam other than the serving beam includes a cell identity and a beam identity, reception power or reception quality.

In a terminal apparatus according to an aspect of the present invention, the reception power or reception quality is calculated from a channel state information reference signal.

A communication method according to an aspect of the present invention is a communication method in a base station apparatus configured to communicate with a terminal apparatus, the method including the steps of, transmitting a measurement configuration as configuration information of measurement performed by the terminal apparatus, and receiving a measurement report from the terminal apparatus, in which the measurement configuration includes a report configuration, and a measuring beam list, the report configuration includes a configuration indicating a periodic reporting or an event-based reporting, and the measuring beam includes a cell identity and a beam identity.

A communication method according to an aspect of the present invention is a communication method in a terminal apparatus configured to communicate with a base station apparatus, the method including the steps of, receiving a measurement configuration as configuration information of measurement from the base station apparatus, and transmitting a measurement report to the base station apparatus, in which the measurement configuration includes a report configuration, and a measuring beam list, the report configuration includes a configuration indicating a periodic reporting or an event-based reporting, and the measuring beam includes a cell identity and a beam identity.

### Effects of the Invention

According to an aspect of the present invention, throughput can be enhanced with suited beamforming.

### BRIEF DESCRIPTION OF THE DRAWINGS

FIG. 1 is a diagram illustrating an example of a communication system according to the present embodiment.

FIG. 2 is a diagram illustrating an example of a frame structure according to the present embodiment.

FIG. 3 is a diagram illustrating an example of a frame structure according to the present embodiment.

FIG. 4 is a diagram illustrating an example of the communication system according to the present embodiment.

FIGS. 5A and 5B are diagrams illustrating examples of the communication system according to the present embodiment.

FIG. 6 is a block diagram illustrating a configuration example of a base station apparatus according to the present embodiment.

FIG. 7 is a block diagram illustrating a configuration example of a terminal apparatus according to the present embodiment.

### MODE FOR CARRYING OUT THE INVENTION

A communication system according to the present embodiment includes a base station apparatus (a transmission device, a cell, a transmission point, a group of transmit antennas, a group of transmit antenna ports, component carriers, eNodeB), and terminal apparatuses (a terminal, a mobile terminal, a reception point, a reception terminal, a reception device, a group of receive antennas, a group of receive antenna ports, UE). The base station apparatus connected to the terminal apparatus (a radio link is established) is referred to as a serving cell.

The base station apparatus and the terminal apparatus according to the present embodiment can communicate in a frequency band for which a license is required (licensed band) and/or in a frequency band for which a license is not required (unlicensed band).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

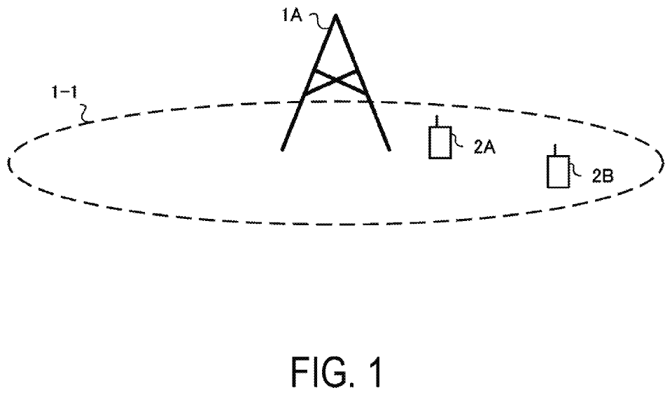

FIG. 1 is a diagram illustrating an example of a communication system according to the present embodiment. As illustrated in FIG. 1, the communication system according to the present embodiment includes a base station apparatus 1A and terminal apparatuses 2A and 2B. Coverage 1-1 is a range (a communication area) in which the base station apparatus 1A can connect to the terminal apparatuses. The terminal apparatuses 2A and 2B are also collectively referred to as terminal apparatuses 2.

With respect to FIG. 1, the following uplink physical channels are used for uplink radio communication from the terminal apparatus 2A to the base station apparatus 1A. The uplink physical channels are used for transmission of information output from higher layers.
Physical Uplink Control CHannel (PUCCH)
Physical Uplink Shared CHannel (PUSCH)
Physical Random Access CHannel (PRACH)

PUCCH is used for transmission of Uplink Control Information (UCI). The Uplink Control Information includes a positive ACKnowledgement (ACK) or a Negative ACKnowledgement (NACK) (ACK/NACK) for downlink data (a downlink transport block or a Downlink-Shared CHannel (DL-SCH)). ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared CHannel (UL-SCH) resource. The Channel State Information refers to a Rank Indicator (RI) specifying a suited number of spatial multiplexing, a Precoding Matrix Indicator (PMI) specifying a suited precoder, a Channel Quality Indicator (CQI) specifying a suited transmission rate, a CSI-Reference Signal (RS) Resource Indication (CRI) indicating a suited CSI-RS resource, and the like.

The Channel Quality Indicator (hereinafter, referred to as a CQI value) can be a suited modulation scheme (e.g., QPSK, 16QAM, 64QAM, 256QAM, or the like) and a suited coding rate in a prescribed band (details of which will be described later). The CQI value can be an index (CQI Index) determined by the above change scheme, coding rate, and the like. The CQI value can take a value determined beforehand in the system.

The Rank Indicator and the Precoding Quality Indicator can take the values determined beforehand in the system. Each of the Rank Indicator, the Precoding Matrix Indicator, and the like can be an index determined by the number of spatial multiplexing, Precoding Matrix information, or the like. Note that values of the Rank Indicator, the Precoding Matrix Indicator, and the Channel Quality Indicator (CQI) are collectively referred to as CSI values.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the Uplink Control Information only.

PUSCH is used to transmit an RRC message. The RRC message is a signal/information that is processed in a Radio Resource Control (RRC) layer. Further, PUSCH is used to transmit an MAC Control Element (CE). Here, MAC CE is a signal/information that is processed (transmitted) in a Medium Access Control (MAC) layer.

For example, a power headroom may be included in MAC CE and may be reported via PUSCH. In other words, a MAC CE field may be used to indicate a level of the power headroom.

PRACH is used to transmit a random access preamble.

In the uplink radio communication, an UpLink Reference Signal (UL RS) is used as an uplink physical signal. The uplink physical signal is not used for transmission of information output from higher layers, but is used by the physical layer. The Uplink Reference Signal includes a DeModulation Reference Signal (DMRS) and a Sounding Reference Signal (SRS).

DMRS is associated with transmission of PUSCH or PUCCH. For example, the base station apparatus 1A uses DMRS in order to perform channel compensation of PUSCH or PUCCH. SRS is not associated with the transmission of PUSCH or PUCCH. For example, the base station apparatus 1A uses SRS to measure an uplink channel state.

In FIG. 1, the following downlink physical channels are used for the downlink radio communication from the base station apparatus 1A to the terminal apparatus 2A. The downlink physical channels are used for transmission of information output from higher layers.
Physical Broadcast CHannel (PBCH)
Physical Control Format Indicator CHannel (PCFICH)
Physical Hybrid automatic repeat request Indicator CHannel (PHICH)
Physical Downlink Control CHannel (PDCCH)
Enhanced Physical Downlink Control CHannel (EPDCCH)
Physical Downlink Shared CHannel (PDSCH)

PBCH is used for broadcasting a Master Information Block (MIB, a Broadcast CHannel (BCH)) that is shared by the terminal apparatuses. PCFICH is used for transmission of information indicating a region (e.g., the number of OFDM symbols) to be used for transmission of PDCCH.

PHICH is used for transmission of ACK/NACK with respect to uplink data (a transport block, a codeword) received by the base station apparatus 1A. In other words, PHICH is used for transmission of a HARQ indicator (HARQ feedback) indicating ACK/NACK with respect to the uplink data. Note that ACK/NACK is also called HARQ-ACK. The terminal apparatus 2A reports ACK/NACK having been received to a higher layer. ACK/NACK refers to ACK indicating a successful reception, NACK indicating an unsuccessful reception, and DTX indicating that no corresponding data is present. In a case that PHICH for uplink data is not present, the terminal apparatus 2A reports ACK to a higher layer.

PDCCH and EPDCCH are used for transmission of Downlink Control Information (DCI). Here, multiple DCI formats are defined for transmission of the downlink control information. In other words, a field for the downlink control information is defined in a DCI format and is mapped to information bits.

For example, as a DCI format for the downlink, a DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, a TPC command for PUCCH, and the like. Here, the DCI format for the downlink is also referred to as downlink grant (or downlink assignment).

Furthermore, for example, as a DCI format for the uplink, a DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, a TPC command for PUSCH, and the like. Here, the DCI format for the uplink is also referred to as uplink grant (or uplink assignment).

Further, the DCI format for the uplink can be used to request downlink Channel State Information (CSI), which is also called reception quality information.

The DCI format for the uplink can be used for a configuration indicating an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (periodic CSI). The CSI feedback report can be used for a mode configuration (CSI report mode) to periodically report the Channel State Information.

For example, the CSI feedback report can be used for a configuration indicating an uplink resource to report aperiodic Channel State Information (aperiodic CSI). The CSI feedback report can be used for a mode configuration (CSI report mode) to aperiodically report the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration indicating a type of the CSI feedback report that is fed back to the base station apparatus by the terminal apparatus. The type of the CSI feedback report includes wideband CSI (e.g., Wideband CQI), narrowband CSI (e.g., Subband CQI), and the like.

In a case where a PDSCH resource is scheduled in accordance with the downlink assignment, the terminal apparatus receives downlink data on scheduled PDSCH. In a case where a PUSCH resource is scheduled in accordance with the uplink grant, the terminal apparatus transmits uplink data and/or uplink control information of scheduled PUSCH.

PDSCH is used for transmission of downlink data (a downlink transport block, DL-SCH). PDSCH is used to transmit a system information block type 1 message. The system information block type 1 message is cell-specific information.

PDSCH is used to transmit a system information message. The system information message includes a system information block X other than the system information block type 1. The system information message is cell-specific information.

PDSCH is used to transmit an RRC message. Here, the RRC message transmitted from the base station apparatus may be shared by multiple terminal apparatuses in a cell. Further, the RRC message transmitted from the base station apparatus 1A may be a dedicated message to a given terminal apparatus 2 (also referred to as dedicated signaling). In other words, user-equipment-specific information (unique to user equipment) is transmitted using a message dedicated to the given terminal apparatus. PDSCH is used for transmission of MAC CE.

Here, the RRC message and/or MAC CE is also referred to as higher layer signaling.

PDSCH can be used to request downlink channel state information. PDSCH can be used for transmission of an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (periodic CSI). The CSI feedback report can be used for a mode configuration (CSI report mode) to periodically report the Channel State Information.

The type of the downlink CSI feedback report includes wideband CSI (e.g., Wideband CSI) and narrowband CSI (e.g., Subband CSI). The wideband CSI calculates one piece of Channel State Information for the system band of a cell. The narrowband CSI divides the system band in prescribed units, and calculates one piece of Channel State Information for each division.

In the downlink radio communication, a Synchronization signal (SS) and a DownLink Reference Signal (DL RS) are used as downlink physical signals. The downlink physical signals are not used for transmission of information output from the higher layers, but are used by the physical layer.

The Synchronization signal is used for the terminal apparatus to be synchronized to frequency and time domains in the downlink. The Downlink Reference Signal is used for the terminal apparatus to perform channel compensation on a downlink physical channel. For example, the Downlink Reference Signal is used for the terminal apparatus to calculate the downlink Channel State Information.

Here, the Downlink Reference Signals include a Cell-specific Reference Signal (CRS), a UE-specific Reference Signal (URS) or a terminal apparatus-specific reference signal relating to PDSCH, a DeModulation Reference Signal (DMRS) relating to EPDCCH, a Non-Zero Power Chanel State Information-Reference Signal (NZP CSI-RS), and a Zero Power Chanel State Information-Reference Signal (ZP CSI-RS).

CRS is transmitted in all bands of a subframe and is used to perform demodulation of PBCH/PDCCH/PHICH/PCFICH/PDSCH. URS relating to PDSCH is transmitted in a subframe and a band that are used for transmission of PDSCH to which URS relates, and is used to demodulate PDSCH to which URS relates.

DMRS relating to EPDCCH is transmitted in a subframe and a band that are used for transmission of EPDCCH to which DMRS relates. DMRS is used to demodulate EPDCCH to which DMRS relates.

A resource for NZP CSI-RS is configured by the base station apparatus 1A. The terminal apparatus 2A performs signal measurement (channel measurement), using NZP CSI-RS. A resource for ZP CSI-RS is configured by the base station apparatus 1A. With zero output, the base station apparatus 1A transmits ZP CSI-RS. The terminal apparatus 2A performs interference measurement in a resource to which NZP CSI-RS corresponds, for example.

A Multimedia Broadcast multicast service Single Frequency Network (MBSFN) RS is transmitted in all bands of the subframe used for transmitting PMCH. MBSFN RS is used to demodulate PMCH. PMCH is transmitted on the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channels and the uplink physical channels are collectively referred to as physical channels. The downlink physical signals and the uplink physical signals are also collectively referred to as physical signals.

BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword and subject to coding processing or the like on a codeword basis.

The base station apparatus can communicate with the terminal apparatus supporting Carrier Aggregation (CA) by integrating multiple Component Carriers (CCs) for wider broadband transmission. In the carrier aggregation, one Primary Cell (PCell) and one or multiple Secondary Cells (SCells) are configured as a group of serving cells.

In Dual Connectivity (DC), as a group of serving cells, a Master Cell Group (MCG), and a Secondary Cell Group (SCG) are configured. MCG is constituted of PCell and optional one or multiple SCells. SCG is constituted of a primary SCell (PSCell) and optional one or multiple SCells.

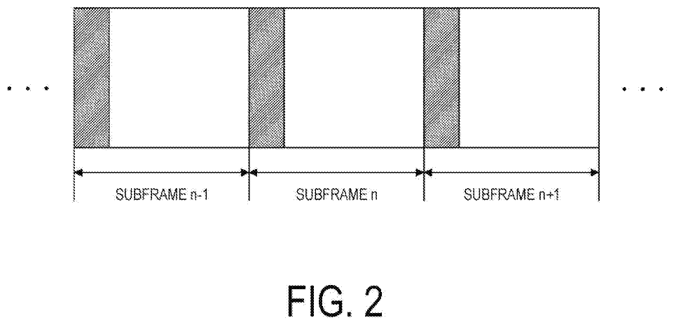

The base station apparatus can communicate using a radio frame. In the radio frame, a reference signal, a synchronization signal, a discovery signal, a control signal, a data signal, and the like are arranged. As a radio frame structure, there are a frame structure in which a reference signal or the like in common in a cell is non-contiguously transmitted in a subframe, and a frame structure in which a reference signal and a data signal in common are distinguished in terms of domain/time, and the like. The base station apparatus can communicate using a radio frame structure illustrated in FIG. 2, for example. In an area hatched toward a top right illustrated in FIG. 2, a reference signal, a synchronization signal, a discovery signal, a control signal, and the like in common in a cell such as CRS are arranged. The discovery signal includes part or all of CRS, the synchronization signal, and CSI-RS. In a whited area, a reference signal, a data signal, a control signal, and the like specific to the terminal are arranged. In the following descriptions, the area hatched toward the top right is also referred to a preamble area, and the whited area is also referred to a data area, unless otherwise noted. The preamble area and the data area are constituted of one or multiple symbols. Hereinafter, a symbol included in the preamble area is referred to as a preamble symbol, a symbol included in the data area is referred to as a data symbol. Although the following embodiment is described using a frame structure in which the preamble area and the data area are separated, the present invention is not limited thereto, and the present invention can be applied independent of arrangement of a signal included in the preamble area and a signal included in the data area.

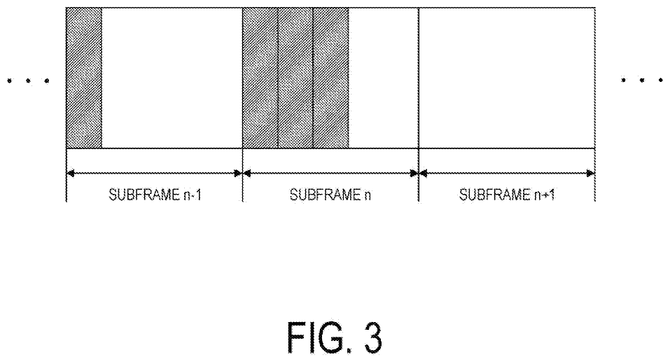

A range (the number of symbols) for each of the preamble area and the data area can be changed. FIG. 3 is an example in which the ranges are changed for respective subframes. n in the drawing is an integer not less than one. A subframe n in FIG. 3 is allocated a larger preamble area than that in a subframe n−1. As illustrated in a subframe n+1 in FIG. 3, it is possible to constitute a subframe with no preamble area and only with a data area. Although not illustrated, it is also possible to constitute a subframe only with a preamble area.

The base station apparatus can indicate a range of the preamble area/data area to the terminal apparatus. The range of the preamble area/data area can be, for example, the number of symbols included in the preamble area/data area. Alternatively, the base station apparatus can indicate whether there is the preamble area/data area to the terminal apparatus.

The base station apparatus can periodically configure the preamble area. For example, the base station apparatus can transmit a preamble area having less symbols at shorter cycles, and can transmit a preamble area having more symbols at longer cycles.

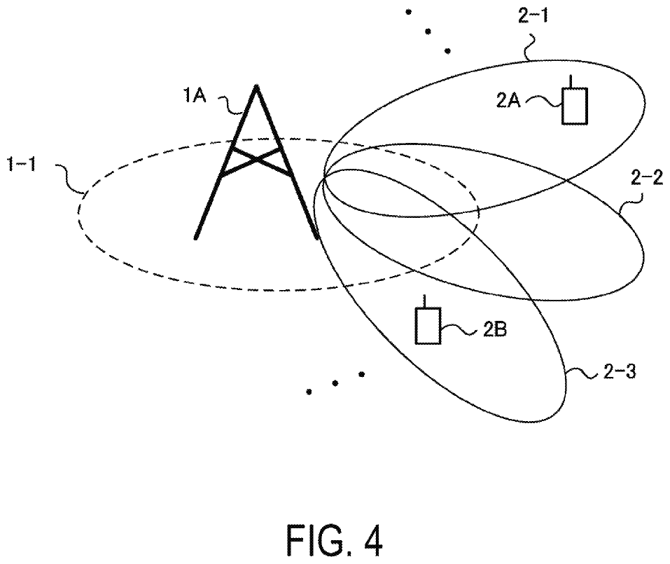

The base station apparatus, in a case of communicating in a high frequency band such as 6 GHz or greater, can communicate using beamforming in order to secure a coverage. FIG. 4 is an example of a communication system using beamforming. The communication system includes the base station apparatus 1A and the terminal apparatuses 2A and 2B. A communication distance of a coverage 1-1 capable of covering wide directions is short, thus the terminal apparatuses 2A and 2B are out of a communication area in this example. Meanwhile, coverages 2-1 to 2-3 are coverages in a case of using the beamforming, and the respective coverages have different beam patterns. In the case of using the beamforming, only narrow directions can be covered, but the communication distance increases. Thus, the terminal apparatus 2A is inside the coverage 2-1, the terminal apparatus 2B is inside the coverage 2-3, and the base station apparatus 1A and the terminal apparatuses 2A and 2B can be connected. However, the base station apparatus 1A, and the terminal apparatuses 2A and 2B need to search which beam pattern is to be used at initial connection time in order to be inside a communication area. Note that a communication area in which the beamforming is used is also referred to as a beam cell or a beam area. A beam connected to the terminal apparatus (a radio link is established) is referred to as a serving beam.

The terminal apparatus synchronizes in terms of time/frequency using a preamble signal, and performs cell search for detecting a physical cell identity (PCID, cell ID) and/or beam search for detecting a beam identity (beam ID, beam cell ID). The cell ID may include the beam ID. In order to be distinguished from a cell ID including no beam ID, a cell ID including a beam ID is also referred to as an enhanced cell ID. For the terminal apparatus to perform the beam search, the base station apparatus can perform the beamforming for part or all of signals included in a preamble for transmission. The preamble signal/discovery signal can include one or multiple signals subjected to the beamforming. For example, the preamble signal can include one or multiple synchronization signals/CRSs/discovery signals subjected to the beamforming. Further, for example, the discovery signal can include one or multiple synchronization signals/CRSs/CSI-RSs subjected to the beamforming. The base station apparatus can change the beam pattern for each preamble area or for each preamble symbol. The beam pattern may include a pattern in which the beamforming is not performed. The base station apparatus, in a case of transmitting a synchronization signal subjected to the beamforming, transmits a synchronization signal with which the base station apparatus and the beam pattern can be identified. In a case that a synchronization signal is generated based on a cell ID and a beam ID, the terminal apparatus can know the cell ID and the beam ID from a synchronization signal sequence. In a case that the base station apparatus changes the beam pattern based on a radio resource such as a slot or a subframe in which the synchronization signal is arranged, the synchronization signal is generated based on the cell ID and information of the radio resource. The information of the radio resource is, for example, a slot/subframe number or a subband number.

The base station apparatus can multiplex (add, superimpose) preamble signals/synchronization signals/discovery signals subjected to the beamforming with different beam patterns to arrange in one preamble area or one preamble symbol for transmission. In other words, the base station apparatus can multiplex (add, superimpose) preamble signals/synchronization signals/discovery signals generated based on different beam IDs to arrange in one preamble area or one preamble symbol for transmission. At this time, the terminal apparatus can know a cell ID and/or a beam ID from a preamble signal/synchronization signal/discovery signal having excellent communication quality.

The number of types of synchronization signals may be one or multiple. In a case that two types of synchronization signals exist, that is a Primary Synchronization Signal (PSS, a first synchronization signal) and a Secondary Synchronization Signal (SSS, a second synchronization signal), it is sufficient that a cell ID and/or a beam ID can be known using both PSS and SSS. Further, respective types may have different functions. For example, the cell ID can be identified by PSS, and the beam ID can be identified by SSS. In another example, the cell Id can be identified by PSS and SSS, and the beam ID can be identified by another synchronization signal (a third synchronization signal).

As described above, a suited beam can be selected in the base station apparatus by the beam search at the initial connection time. At this time, it is also preferable for the terminal apparatus to perform the beam search. A beam in the terminal apparatus can be used for a reception beam in the terminal apparatus, an uplink transmission beam, or the like. As for the beam search in the terminal apparatus, different synchronization signal sequences subjected to identical beamforming are preferable. Accordingly, the base station apparatus arranges different sequences of synchronization signals subjected to the beamforming with an identical beam pattern in a preamble area for transmission. A synchronization signal that can be used for the beam search in the terminal apparatus may be arranged in one subframe or in multiple subframes.

Multiple synchronization signals that the base station apparatus arranges in a preamble area may simultaneously include a synchronization signal based on different synchronization signal sequences subjected to identical beamforming, and different synchronization signal sequences subjected to different beamforming. The base station apparatus can inform the terminal apparatus of information indicating, among the multiple synchronization signals arranged in the preamble area, which is the synchronization signal subjected to the identical beamforming and which is the synchronization signal subjected to the different beamforming. In other words, the base station apparatus can continuously transmit a synchronization signal associated with beam search of the base station apparatus and a synchronization signal associated with beam search of the terminal apparatus to be described later in the preamble area.

The terminal apparatus can search a beam of the terminal apparatus in a case of performing the beam search of the base station apparatus. The terminal apparatus can search a beam of the terminal apparatus in a case of being indicated by the base station apparatus. The terminal apparatus can periodically search a beam of the terminal apparatus. A cycle of the beam search of the terminal apparatus is indicated by the base station apparatus.

In a case that the terminal apparatus moves or the like, communication environment is possibly changed, thus the base station apparatus needs to update a beam pattern. The base station apparatus transmits a measurement configuration as configuration information for clarifying measurement performed by the terminal apparatus to the terminal apparatus. The measurement configuration includes part or all of a measurement object list, a report configuration list, a measurement ID list, and other parameters. A measurement object is information for cell information and includes part or all of a carrier frequency, a measurement bandwidth, an antenna port, a list of cells reporting respective measurement results, a black cell list constituted of cells not reporting respective measurement result, a DS configuration for measurement, a list of beams reporting respective measurement results, and a list of black beams not reporting respective measurement results. A cell reporting a measurement result includes a cell index, a physical cell ID, and a cell specific offset as parameters. A beam reporting a measurement result includes part or all of a beam ID and a physical cell ID. A report configuration includes a trigger type indicating a periodic reporting or an event-based reporting. In the case of the event-based reporting, the report configuration includes an event ID. For example, there are event IDs described below, and a threshold (a threshold 1 or a threshold 2, as necessary), an offset value and the like necessary for condition calculation are also configured.

Event A1: a case in which a measurement result of a serving cell becomes better than a configured threshold

Event A2: a case in which the measurement result of the serving cell becomes worse than the configured threshold

Event A3: a case in which a measurement result of a neighbor cell becomes better than a measurement result of PCell/PSCell by more than a configured offset value

Event A4: a case in which the measurement result of the neighbor cell becomes better than the configured threshold

Event A5: a case in which the measurement result of PCell/PSCell becomes worse than a configured threshold 1 and the measurement result of the neighbor cell becomes better than a configured threshold 2

Event A6: a case in which the measurement result of the neighbor cell becomes better than a measurement result of SCell by more than the configured offset value

Event C1: a case in which a measurement result in a CSI-RS resource becomes better than the configured threshold

Event C2: a case in which the measurement result in the CSI-RS resource becomes better than a measurement result in a reference CSI-RS resource by more than an offset

Event D1: a case in which a measurement result of a serving beam becomes better than the configured threshold

Event D2: a case in which the measurement result of the serving beam becomes worse than the configured threshold

Event D3: a case in which a measurement result of a beam different from the serving beam (neighbor beam) becomes better than the configured threshold

Event E1: a case in which a time that elapses after beam decision by the base station apparatus exceeds a threshold

Event E2: a case in which a time that elapses after beam decision by the terminal apparatus exceeds a threshold

Event E3: a case of both E1 and E2

Note that the events C1 and C2 are selected in a case that a DS configuration for measurement is configured in a measurement object.

The DS configuration for measurement is information applicable to measurement with a discovery signal, and includes a cycle and an offset of a discovery signal measurement timing configuration, a duration of discovery signal occasion, and a list of CSI-RSs for measurement. A configuration of CSI-RS for measurement includes ID of CSI-RS for measurement, the physical cell ID, a scrambling identity for pseudo-random sequence generation, a resource configuration as a configuration of CSI-RS, subframe offsets of SSS and CSI-RS in the discovery signal, and individual offset of CSI-RS. The CSI-RS for measurement is arranged in a preamble area and/or a data area.

The terminal apparatus reports a measurement result of a serving cell, a serving beam, a cell list, a beam list, a detected cell, or a detected beam to the base station apparatus. The terminal apparatus reports a measurement result periodically or in a case of an event, according to indication by the base station apparatus. The measurement result that the terminal apparatus reports to the base station apparatus includes part or all of a measurement ID, a measurement result of PCell, measurement result list of neighbor cells, a measurement result of a serving frequency, a measurement result list of CSI-RSs, a measurement result of a beam in PCell, a measurement result list of beams in SCell, and a measurement result list of beams other than a serving beam (neighbor beam). The measurement result of PCell includes Reference Signal Received Power (RSRP) and Reference Signal Received Quality (RSRQ). RSRP is reception power calculated using CRS. RSRQ is obtained from a ratio of RSRP to a Received Signal Strength Indicator (RSSI). The measurement result of a neighbor cell includes part or all of a physical cell ID, RSRP, and RSRQ. A measurement result list of serving frequencies includes a serving cell index for identifying the serving cell, the measurement result of SCell, and a measurement result of a neighbor cell having the best measurement result. The measurement result of SCell and the measurement result of the neighbor cell having the best measurement result include RSRP and RSRQ. The measurement result of CSI-RS includes part or all of the ID of CSI-RS for measurement, CSI-RSRP, and CSI-RSRQ. CSI-RSRP is reception power calculated using CSI-RS. CSI-RSRQ is obtained from a ratio of CSI-RSRP to RSSI. The measurement result of a beam in PCell includes part or all of the physical cell ID, a beam 1D, RSRP, and RSRQ. The measurement result of a beam in SCell includes part or all of the physical cell ID, the beam ID, RSRP, and RSRQ. The measurement result of the beam other than the serving beam includes part or all of the physical cell ID, the beam ID, RSRP, and RSRQ.

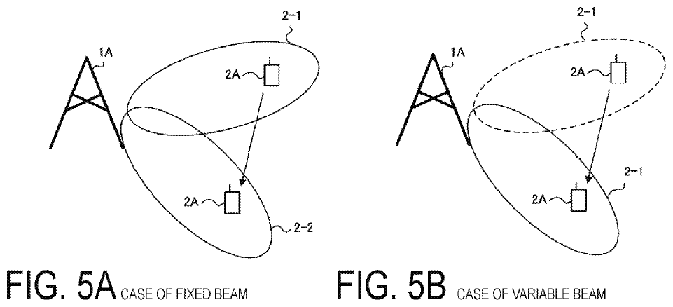

In a case that a measurement result of another beam pattern is improved and the base station apparatus changes a beam pattern, a beam ID may be changed or unchanged in the terminal apparatus. In a case that the beam ID is changed, the base station apparatus forms multiple fixed beams having respective different beam IDs, and in a case that the terminal apparatus moves to a different beam area, a different beam ID is allocated. Further, in a case that the beam ID is not changed, a beam ID of the terminal apparatus is not changed even in a case that the terminal apparatus moves and a beam pattern is changed. In this case, more flexible beam control is possible. FIGS. 5A and 5B illustrate respective examples of a fixed beam and a variable beam. A communication system in FIGS. 5A and 5B include the base station apparatus 1A and the terminal apparatus 2A. Beam areas 2-1 and 2-2 are communication areas having respective different beam IDs.

In a case of the fixed beam, the terminal apparatus 2A moves in an arrow direction as illustrated in FIG. 5A. At this time, in a case that communication quality of the beam area 2-1 is deteriorated, and communication quality of the beam area 2-2 is improved, the base station apparatus 1A switches a beam ID of the terminal apparatus 2A to a beam ID of the beam area 2-2. The base station apparatus 1A transmits a new beam ID to the terminal apparatus 2A. The terminal apparatus 2A performs synchronization, RPM measurement, CSI measurement/report, data demodulation, and the like, using the beam ID received from the base station apparatus 1A.

In a case of the variable beam, the terminal apparatus 2A moves in an arrow direction as illustrated in FIG. 5B. In a case that the terminal apparatus 2A moves and a suited beam pattern changes, the base station apparatus 1A does not change the beam ID of the terminal apparatus 2A and changes a beam pattern. At this time, the terminal apparatus 2A can communicate without knowing that the beam pattern is changed. The base station apparatus 1A receives a report for the suited beam pattern from the terminal apparatus 2A and can know the suited beam pattern of the terminal apparatus 2A.

In a case that reception quality of the terminal apparatus 2A is rapidly deteriorated due to radio shielding and the like by another mobile object, the above-described handover cannot follow the rapid deterioration in the reception quality in some cases. In this case, the base station apparatus 1A and the terminal apparatus 2A can change a frequency band for communication. For example, in a case that communication quality between the base station apparatus 1A and the terminal apparatus 2A that communicate in a frequency band of 6 GHz or greater is rapidly deteriorated, the base station apparatus 1A and the terminal apparatus 2A can switch a communication frequency to a frequency band of 6 GHz or less. In a case that improvement in the communication quality of the frequency band before the switching is recognized after the base station apparatus 1A and the terminal apparatus 2A had switched the frequency band once, the base station apparatus 1A and the terminal apparatus 2A can switch the communication frequency to the frequency band before the switching again. In this case, each of the base station apparatus 1A and the terminal apparatus 2A can continuously use the beamforming used before the switching. The base station apparatus 1A and the terminal apparatus 2A, in a case that the communication frequency is switched to the frequency band before the switching, may perform beam search again, or may switch the communication frequency after performing beam search of the frequency band before the switching again. Combinations of switchable frequency bands may be predetermined. The combinations of switchable frequency bands can be linked to carrier aggregation, dual connectivity, or the like. The combinations of frequency bands depend on a function of the terminal apparatus (UE capability). For example, the base station apparatus 1A can switch to a frequency band indicated by a combination of frequency bands included in a function of the terminal apparatus received from the terminal apparatus 2A.

In a case that the base station apparatus communicates with multiple terminal apparatuses with differently configured beam IDs, each of the terminal apparatuses may receive inter-beam interference. The base station apparatus, in a case of avoiding the inter-beam interference, can divide a time/frequency/space resource for transmission. In a case of dividing a space resource, for example, the base station apparatus can divide antenna ports among the terminal apparatuses for transmission. Additionally, in another example, although an identical antenna port is allocated among the terminal apparatuses, it is possible to transmit to the terminal apparatuses using different beam patterns separately. In a case that the terminal apparatus supports a function for eliminating or suppressing the inter-beam interference, the base station apparatus can transmit assist information (neighbor beam information) for eliminating or suppressing the inter-beam interference (neighbor beam interference) to the terminal apparatus. The terminal apparatus can eliminate or suppress the inter-beam interference using the received assist information. The assist information includes part or all of the physical cell ID, the beam ID, the number of CRS ports, a PA list, PB, a Multimedia Broadcast multicast service Single Frequency Network (MBSFN) subframe configuration, a transmission mode list, resource allocation granularity, a UL/DL subframe structure of TDD, ZP/NZP CSI-RS structure, and quasi co-location (QCL) information. PA is a power ratio (power offset) of PDSCH to CRS in an OFDM symbol where CRS is not allocated. PB indicates a power ratio (power offset) of PDSCH in an OFDM symbol where CRS is allocated to PDSCH in an OFDM symbol where CRS is not allocated. The QCL information is information associated with QCL for a prescribed antenna port, a prescribed signal, or a prescribed channel. In a case that in two antenna ports, long term performance of a channel in which a symbol on one antenna port is transported can be guessed from a channel in which a symbol on the other antenna port is transported, each of the antenna ports is referred to as QCL. The long term performance includes a delay spread, a doppler spread, a doppler shift, an average gain and/or an average delay. That is, in a case that each of the two antenna ports is QCL, the terminal apparatus can regard the long term performance in the antenna ports as identical. In each of the parameters included in the above-described assist information, one value (candidate) may be configured, or multiple values (candidates) may be configured. In the case of multiple values being configured in a parameter, the terminal apparatus interprets that values that an interfering base station apparatus may configure are indicated for the parameter, and detects (specifies) a parameter configured in an interference signal among the multiple values. The above-described assist information indicates information of another base station apparatus/beam in some cases, or indicates information of own base station apparatus/beam in some cases. In addition, the above-described assist information may be used in a case that various types of measurement are performed. The stated measurement includes Radio Resource Management (RRM) measurement, Radio Link Monitoring (RLM) measurement, and Channel State Information (CSI) measurement.

The base station apparatus can additionally perform, for the terminal apparatus, beamforming specific to the terminal in a beam area. The base station apparatus can also precode based on a codebook, PMI, or the like, and perform unique beamforming of the base station apparatus. The base station apparatus can know suited CSI by a CSI report from the terminal apparatus. CSI reported by the terminal apparatus includes CQI/PMI/RI/CRI. The base station apparatus can know a suited beam pattern of the terminal apparatus from CSI calculated from CSI-RS. CSI-RS can transmit (configure) CSI-RS not subjected to beamforming (non-precoded CSI-RS) and/or CSI-RS subjected to beamforming (beamformed CSI-RS). CSI-RS is arranged in a preamble area and/or a data area. The base station apparatus can include information of the non-precoded CSI-RS or information of the beamformed CSI-RS in configuration information of CSI-RS. The information of the non-precoded CSI-RS includes part or all of information for CodeBook Subset Restriction (CBSR), information for a codebook, and interference measurement restriction as a configuration for whether a resource at a time of interference measurement is restricted. The information of the beamformed CSI-RS includes part or all of an ID list of CSI-RS configurations, an ID list of CSI-Interference Measurement (CSI-IM) configurations, information for the CodeBook Subset Restriction, and channel measurement restriction as a configuration for whether a resource at a time of channel measurement is restricted. The ID list of CSI-IM configuration is constituted of one or multiple pieces of ID information of CSI-IM configurations, ID information of the CSI-IM configuration including part or all of a CSI-IM configuration ID and interference measurement restriction. CSI-IM is used for interference measurement.

The base station apparatus can associate signalling of higher layers with at least CSI-RS for the channel measurement and CSI-IM for the interference measurement to include a configuration for a procedure to calculate Channel State Information (CSI process). The CSI process can include part or all of a CSI process ID thereof, the information of the non-precoded CSI-RS, and the information of the beamformed CSI-RS. The base station apparatus can configure one or more CSI processes. The base station apparatus can generate feedback of CSI independently for each of the CSI processes. The base station apparatus can configure a CSI-RS resource and CSI-IM differently for each of the CSI processes. One or more CSI processes are configured for the terminal apparatus, and the terminal apparatus performs CSI reporting independently for each of the configured CSI processes. The CSI processes are configured in a prescribed transmission mode.

The beam ID and the beamforming described above can be configured for each cell. The beam ID and the beamforming described above may be configured for PCell and SCell, and may be configured only for Pcell or only for SCell. There may be a radio frame for which the beam ID and the beamforming described above can be configured and there may be a radio frame for which none can be configured. In this case, the radio frame for which the beam ID and the beamforming can be configured and the radio frame for which none can be configured can be CA or DC. For example, the radio frame for which the beam ID and the beamforming can be configured is configured for PCell/SCell, and the radio frame for which the beam ID and the beamforming cannot be configured is configured for PSCell/SCell. Additionally, for example, the radio frame for which the beam ID and the beamforming cannot be configured is configured for PCell/SCell, and the radio frame for which the beam ID and the beamforming can be configured is configured for PSCell/SCell.

The base station apparatus and the terminal apparatus can configure beamforming configured for one CC (cell) for another CC. The base station apparatus and the terminal apparatus can perform beam search only in a prescribed CC (for example, CC configured as PCell/SCell). The base station apparatus and the terminal apparatus can configure a condition of CCs for which identical beamforming can be configured. For example, the base station apparatus and the terminal apparatus can configure identical beamforming among CCs for which differences between central frequencies are smaller than a prescribed value. Alternatively, the base station apparatus and the terminal apparatus can configure identical beamforming in an identical frequency band (Intra-band).

Note that, as for a beam pattern formed by beamforming performed by the base station apparatus and the terminal apparatus, antenna gain in a maximum radiation direction can be decided, in accordance with transmit power (antenna power) in each of the apparatuses. For example, the base station apparatus and the terminal apparatus, in a case that the antenna power exceeds 10 dBm, can make the antenna gain in the maximum radiation direction of the beam pattern greater than 10 dBi.

As for the beam pattern formed by the beamforming performed by the base station apparatus and the terminal apparatus, the antenna gain in the maximum radiation direction can be decided, in accordance with types of frequency bands with which the respective apparatuses transmit. For example, antenna gains in the maximum radiation direction can have different values for a case in which the frequency band with which each apparatus transmits is a frequency band referred to as a so-called licensed band for which a usage permission (license) is given from a country or a region in which a radio operator provides services, and for a case in which the frequency band with which each apparatus transmits is a frequency band referred to as a so-called unlicensed band that does not require the usage permission (license) from the country or the region.

The base station apparatus can switch between transmission of a preamble signal/synchronization signal/discovery signal subjected to beamforming or transmission of a preamble signal/synchronization signal/discovery signal not subjected to beamforming, depending on the frequency band. That is, the terminal apparatus can determine whether to perform initial connection assuming the beamforming (beam ID detection) or to perform initial connection not assuming the beamforming, depending on the frequency band.

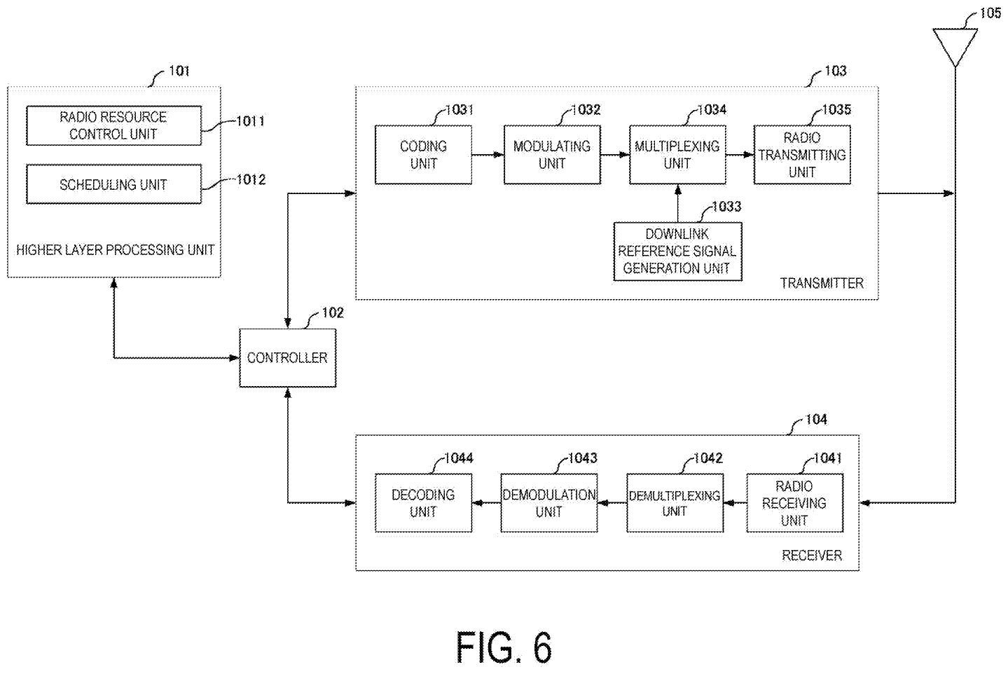

FIG. 6 is a schematic block diagram illustrating a configuration of the base station apparatus 1A according to the present embodiment. As illustrated in FIG. 6, the base station apparatus 1A is configured, including a higher layer processing unit (higher layer processing step) 101, a controller (controlling step) 102, a transmitter (transmitting step) 103, a receiver (receiving step) 104, and a transmit and/or receive antenna 105. The higher layer processing unit 101 is configured, including a radio resource control unit (radio resource controlling step) 1011 and a scheduling unit (scheduling step) 1012. The transmitter 103 is configured, including a coding unit (coding step) 1031, a modulating unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 is configured, including a radio receiving unit (radio receiving step) 1041, a demultiplexing unit (demultiplexing step) 1042, a demodulation unit (demodulating step) 1043, and a decoding unit (decoding step) 1044.

The higher layer processing unit 101 performs processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 101 generates information necessary for control of the transmitter 103 and the receiver 104, and outputs the generated information to the controller 102.

The higher layer processing unit 101 receives information on a terminal apparatus, such as UE capability, from the terminal apparatus. To rephrase, the terminal apparatus transmits its function to the base station apparatus by higher layer signaling.

Note that in the following description, information on a terminal apparatus includes information indicating whether the stated terminal apparatus supports a prescribed function, or information indicating that the stated terminal apparatus has completed the introduction and test of a prescribed function. In the following description, information on whether the prescribed function is supported includes information on whether the introduction and test of the prescribed function have been completed.

For example, in a case where a terminal apparatus supports a prescribed function, the stated terminal apparatus transmits information (parameters) indicating whether the prescribed function is supported. In a case where a terminal apparatus does not support a prescribed function, the stated terminal apparatus does not transmit information (parameters) indicating whether the prescribed function is supported. In other words, whether the prescribed function is supported is reported by whether information (parameters) indicating whether the prescribed function is supported is transmitted. Information (parameters) indicating whether a prescribed function is supported may be reported using one bit of 1 or 0.

The radio resource control unit 1011 generates, or acquires from a higher node, the downlink data (the transport block) arranged in the downlink PDSCH, system information, the RRC message, the MAC Control Element (CE), and the like. The radio resource control unit 1011 outputs the downlink data to the transmitter 103, and outputs other information to the controller 102. Furthermore, the radio resource control unit 1011 manages various configuration information of the terminal apparatuses.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the controller 102.

The scheduling unit 1012 generates the information to be used for the scheduling of the physical channels (PDSCH and PUSCH), based on the result of the scheduling. The scheduling unit 1012 outputs the generated information to the controller 102.

Based on the information input from the higher layer processing unit 101, the controller 102 generates a control signal for controlling of the transmitter 103 and the receiver 104. The controller 102 generates the downlink control information based on the information input from the higher layer processing unit 101, and outputs the generated information to the transmitter 103.

The transmitter 103 generates the downlink reference signal in accordance with the control signal input from the controller 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2 through the transmit and/or receive antenna 105.

The coding unit 1031 codes the HARQ indicator, the downlink control information, and the downlink data that are input from the higher layer processing unit 101, in compliance with the coding scheme prescribed in advance, such as block coding, convolutional coding, or turbo coding, or in compliance with the coding scheme determined by the radio resource control unit 1011. The modulating unit 1032 modulates the coding bits input from the coding unit 1031, in compliance with the modulation scheme prescribed in advance, such as Binary Phase Shift Keying (BPSK), Quadrature Phase Shift Keying (QPSK), quadrature amplitude modulation (16QAM), 64QAM, or 256QAM, or in compliance with the modulation scheme determined by the radio resource control unit 1011.

The downlink reference signal generation unit 1033 generates, as the downlink reference signal, a sequence that is already learned to the terminal apparatus 2A and that is acquired in accordance with a rule prescribed in advance based on the physical cell identity (PCI, cell ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to the resource elements.

The radio transmitting unit 1035 performs Inverse Fast Fourier Transform (IFFT) on the modulation symbol resulting from the multiplexing or the like, generates an OFDM symbol, attaches a Cyclic Prefix (CP) to the generated OFDM symbol, generates a baseband digital signal, converts the baseband digital signal into an analog signal, removes unnecessary frequency components through filtering, up-converts a result of the removal into a signal of a carrier frequency, performs power amplification, and outputs a final result to the transmit and/or receive antenna 105 for transmission.

In accordance with the control signal input from the controller 102, the receiver 104 demultiplexes, demodulates, and decodes the reception signal received from the terminal apparatus 2A through the transmit and/or receive antenna 105, and outputs information resulting from the decoding to the higher layer processing unit 101.

The radio receiving unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 1041 removes a portion corresponding to CP from the digital signal resulting from the conversion. The radio receiving unit 1041 performs Fast Fourier Transform (FFT) on the signal from which CP has been removed, extracts a signal in the frequency domain, and outputs the resulting signal to the demultiplexing unit 1042.

The demultiplexing unit 1042 demultiplexes the signal input from the radio receiving unit 1041 into PUCCH, PUSCH, and the signal such as the uplink reference signal. The demultiplexing is performed based on radio resource allocation information that is determined in advance by the base station apparatus 1A using the radio resource control unit 1011 and that is included in the uplink grant notified to each of the terminal apparatuses 2.

Furthermore, the demultiplexing unit 1042 makes a compensation of channels including PUCCH and PUSCH. The demultiplexing unit 1042 demultiplexes the uplink reference signal.

The demodulation unit 1043 performs Inverse Discrete Fourier Transform (IDFT) on PUSCH, acquires modulation symbols, and performs reception signal demodulation, that is, demodulates each of the modulation symbols of PUCCH and PUSCH, in compliance with the modulation scheme prescribed in advance, such as BPSK, QPSK, 16QAM, 64QAM, 256QAM, or in compliance with the modulation scheme that the base station apparatus 1A itself notified in advance, with the uplink grant, to each of the terminal apparatuses 2.

The decoding unit 1044 decodes the coding bits of PUCCH and PUSCH, which have been demodulated, at the coding rate in compliance with a coding scheme prescribed in advance, the coding rate being prescribed in advance or being notified in advance with the uplink grant to the terminal apparatus 2 by the base station apparatus 1A itself, and outputs the decoded uplink data and uplink control information to the higher layer processing unit 101. In a case where PUSCH is re-transmitted, the decoding unit 1044 performs the decoding with the coding bits input from the higher layer processing unit 101 and retained in an HARQ buffer, and the demodulated coding bits.

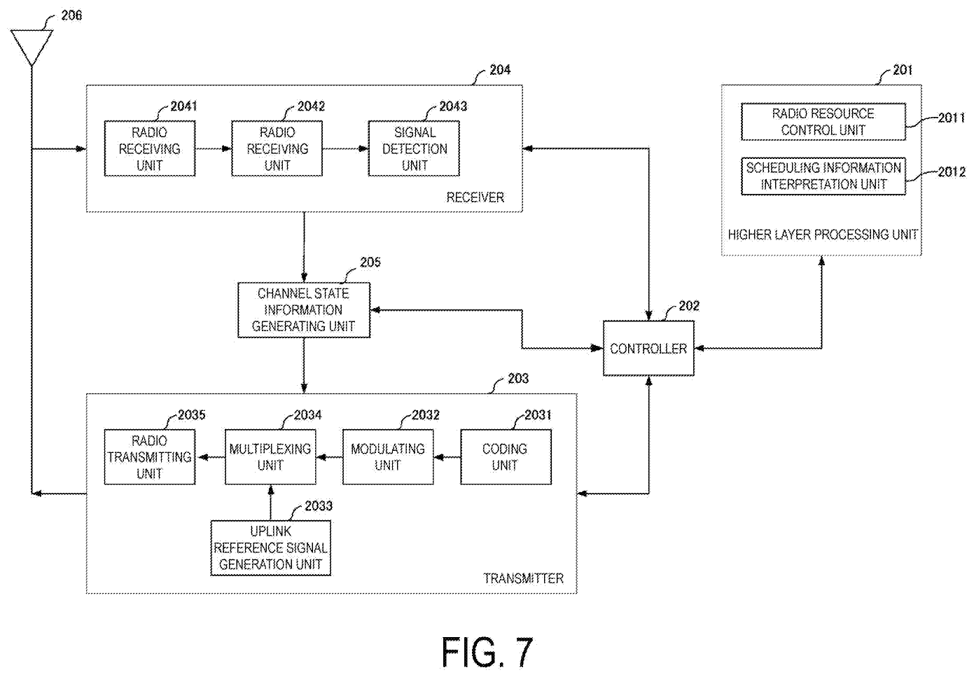

FIG. 7 is a schematic block diagram illustrating a configuration of the terminal apparatus 2 according to the present embodiment. As illustrated in FIG. 7, the terminal apparatus 2A is configured, including a higher layer processing unit (higher layer processing step) 201, a controller (controlling step) 202, a transmitter (transmitting step) 203, a receiver (receiving step) 204, a channel state information generating unit (channel state information generating step) 205, and a transmit and/or receive antenna 206. The higher layer processing unit 201 is configured, including a radio resource control unit (radio resource controlling step 2011 and a scheduling information interpretation unit (scheduling information interpreting step) 2012. The transmitter 203 is configured, including a coding unit (coding step) 2031, a modulating unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 is configured, including a radio receiving unit (radio receiving step) 2041, a demultiplexing unit (demultiplexing step) 2042, and a signal detection unit (signal detecting step) 2043.

The higher layer processing unit 201 outputs the uplink data (the transport block) generated by a user operation or the like, to the transmitter 203. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmitter 203, information indicating a terminal apparatus function supported by the terminal apparatus 2A itself.

Furthermore, the radio resource control unit 2011 manages various configuration information of the terminal apparatuses 2A itself. Furthermore, the radio resource control unit 2011 generates information to be mapped to each uplink channel, and outputs the generated information to the transmitter 203.

The radio resource control unit 2011 acquires configuration information of CSI feedback transmitted from the base station apparatus, and outputs the acquired information to the controller 202.

The scheduling information interpretation unit 2012 interprets the downlink control information received through the receiver 204, and determines scheduling information. The scheduling information interpretation unit 2012 generates the control information in order to control the receiver 204 and the transmitter 203 in accordance with the scheduling information, and outputs the generated information to the controller 202.

On the basis of the information input from the higher layer processing unit 201, the controller 202 generates a control signal for controlling the receiver 204, the channel state information generating unit 205, and the transmitter 203. The controller 202 outputs the generated control signal to the receiver 204, the channel state information generating unit 205, and the transmitter 203 to control the receiver 204 and the transmitter 203.

The controller 202 controls the transmitter 203 to transmit CSI generated by the channel state information generating unit 205 to the base station apparatus.

In accordance with the control signal input from the controller 202, the receiver 204 demultiplexes, demodulates, and decodes a reception signal received from the base station apparatus 1A through the transmit and/or receive antenna 206, and outputs the resulting information to the higher layer processing unit 201.

The radio receiving unit 2041 converts, by down-converting, a downlink signal received through the transmit and/or receive antenna 206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 2041 removes a portion corresponding to CP from the digital signal resulting from the conversion, performs fast Fourier transform on the signal from which CP has been removed, and extracts a signal in the frequency domain.

The demultiplexing unit 2042 demultiplexes the extracted signal into PHICH, PDCCH, EPDCCH, PDSCH, and the downlink reference signal. Further, the demultiplexing unit 2042 makes a compensation of channels including PHICH, PDCCH, and EPDCCH based on a channel estimation value of the desired signal obtained from the channel measurement, detects the downlink control information, and outputs the information to the controller 202. The controller 202 outputs PDSCH and the channel estimation value of the desired signal to the signal detection unit 2043.

The signal detection unit 2043, using PDSCH and the channel estimation value, detects a signal, and outputs the detected signal to the higher layer processing unit 201.

The transmitter 203 generates the uplink reference signal in accordance with the control signal input from the controller 202, codes and modulates the uplink data (the transport block) input from the higher layer processing unit 201, multiplexes PUCCH, PUSCH, and the generated uplink reference signal, and transmits a result of the multiplexing to the base station apparatus 1A through the transmit and/or receive antenna 206.

The coding unit 2031 codes the uplink control information input from the higher layer processing unit 201 in compliance with a coding scheme, such as convolutional coding or block coding. Furthermore, the coding unit 2031 performs turbo coding in accordance with information used for the scheduling of PUSCH.

The modulating unit 2032 modulates coding bits input from the coding unit 2031, in compliance with the modulation scheme notified with the downlink control information, such as BPSK, QPSK, 16QAM, or 64QAM, or in compliance with a modulation scheme prescribed in advance for each channel.

The uplink reference signal generation unit 2033 generates a sequence acquired according to a rule (formula) prescribed in advance, based on a physical cell identity (PCI, also referred to as a cell ID or the like) for identifying the base station apparatus 1A, a bandwidth to which the uplink reference signal is mapped, a cyclic shift notified with the uplink grant, a parameter value for generation of a DMRS sequence, and the like.

In accordance with the control signal input from the controller 202, the multiplexing unit 2034 rearranges modulation symbols of PUSCH in parallel and then performs Discrete Fourier Transform (DFT) on the rearranged modulation symbols. Furthermore, the multiplexing unit 2034 multiplexes PUCCH and PUSCH signals and the generated uplink reference signal for each transmit antenna port. To be more specific, the multiplexing unit 2034 maps the PUCCH and PUSCH signals and the generated uplink reference signal to the resource elements for each transmit antenna port.

The radio transmitting unit 2035 performs Inverse Fast Fourier Transform (IFFT) on a signal resulting from the multiplexing, performs the modulation of SC-FDMA scheme, generates an SC-FDMA symbol, attaches CP to the generated SC-FDMA symbol, generates a baseband digital signal, converts the baseband digital signal into an analog signal, removes unnecessary frequency components, up-converts a result of the removal into a signal of a carrier frequency, performs power amplification, and outputs a final result to the transmit and/or receive antenna 206 for transmission.

A program running on a device according to the present invention may serve as a program that controls a Central Processing Unit (CPU) and the like, and causes a computer to operate in such a manner as to enable the functions of the above-described embodiment according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Moreover, the devices in the above-described embodiment may be partially enabled by a computer. In this case, a program for enabling functions of the embodiment may be recorded on a computer-readable recording medium. The functions may be enabled by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains the program for a short period of time, such as a communication line that is used to transmit the program over a network such as the Internet or over a communication line such as a telephone line, and a medium that retains, in that case, the program for a fixed period of time, such as a volatile memory within the computer system which functions as a server or a client. Furthermore, the program may be configured to enable some of the functions described above, and also may be configured to be capable of enabling the functions described above in combination with a program already recorded in the computer system.

Furthermore, each functional block or various characteristics of the devices used in the above-described embodiment may be mounted or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, a processor of known type, a controller, a micro-controller, or a state machine. The above-mentioned electric circuits may be constituted of a digital circuit, or may be constituted of an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, devices have been described as an example, but the invention of the present application is not limited to these devices, and is applicable to a terminal apparatus or a communication device of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatus.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which a constituent element that achieves the same effect is substituted for the one that is described in the embodiments is also included in the technical scope of the present invention.

### INDUSTRIAL APPLICABILITY

The present invention can be preferably used in a base station apparatus, a terminal apparatus, and a communication method.

The present international application claims priority based on JP 2016-012181 filed on Jan. 26, 2016, and all the contents of JP 2016-012181 are incorporated in the present international application by reference.

### DESCRIPTION OF REFERENCE NUMERALS

1A Base station apparatus
2A, 2B Terminal apparatus
101 Higher layer processing unit
102 Controller
103 Transmitter
104 Receiver
105 Transmit and/or receive antenna
1011 Radio resource control unit
1012 Scheduling unit
1031 Coding unit
1032 Modulating unit
1033 Downlink reference signal generation unit
1034 Multiplexing unit
1035 Radio transmitting unit
1041 Radio receiving unit
1042 Demultiplexing unit
1043 Demodulation unit
1044 Decoding unit
201 Higher layer processing unit
202 Controller
203 Transmitter
204 Receiver
205 Channel state information generating unit
206 Transmit and/or receive antenna
2011 Radio resource control unit
2012 Scheduling information interpretation unit
2031 Coding unit
2032 Modulating unit
2033 Uplink reference signal generation unit
2034 Multiplexing unit
2035 Radio transmitting unit
2041 Radio receiving unit
2042 Demultiplexing unit
2043 Signal detection unit

1. A base station apparatus configured to communicate with a terminal apparatus, the base station apparatus comprising:
a transmitter configured to transmit a measurement configuration as configuration information of measurement performed by the terminal apparatus; and
a receiver configured to receive a measurement report from the terminal apparatus, wherein
the measurement configuration includes a report configuration, and a measuring beam list,
the report configuration includes a configuration indicating a periodic reporting or an event-based reporting, and
the measuring beam includes a cell identity and a beam identity.

2. The base station apparatus according to claim 1, wherein in a case of the event-based reporting, the report configuration includes an event ID and a threshold, and
the event ID indicates a case in which a measurement result of a serving beam as a beam to which the terminal apparatus connects becomes better than the threshold.

3. The base station apparatus according to claim 1, wherein in a case of the event-based reporting, the report configuration includes an event ID and a threshold, and
the event ID indicates a case in which a measurement result of a serving beam as a beam to which the terminal apparatus connects becomes worse than the threshold.

4. The base station apparatus according to claim 1, wherein in a case of the event-based reporting, the report configuration includes an event ID and a threshold, and
the event ID indicates a case in which a measurement result of a beam different from a serving beam as a beam to which the terminal apparatus connects becomes better than the threshold.

5. The base station apparatus according to claim 1, wherein the measurement report includes a measurement result of a serving beam as a beam to which the terminal apparatus connects and/or a measurement result of a beam other than the serving beam.

6. The base station apparatus according to claim 5, wherein a measurement result of the serving beam includes reception power or reception quality, and
a measurement result of a beam other than the serving beam includes a cell identity and a beam identity and reception power or reception quality.

7. The base station apparatus according to claim 6, wherein the reception power or reception quality is calculated from a channel state information reference signal.

8. A terminal apparatus configured to communicate with a base station apparatus, the terminal apparatus comprising:
a receiver configured to receive a measurement configuration as configuration information of measurement from the base station apparatus, and
a transmitter configured to transmit a measurement report to the base station apparatus, wherein
the measurement configuration includes a report configuration, and a measuring beam list,
the report configuration includes a configuration indicating a periodic reporting or an event-based reporting, and
the measuring beam includes a cell identity and a beam identity.

9. The terminal apparatus according to claim 8, wherein in a case of the event-based reporting, the report configuration includes an event ID and a threshold, and
the event ID indicates a case in which a measurement result of a serving beam as a beam to which the terminal apparatus connects becomes better than the threshold.

10. The terminal apparatus according to claim 8, wherein in a case of the event-based reporting, the report configuration includes an event ID and a threshold, and
the event ID indicates a case in which a measurement result of a serving beam as a connecting beam becomes worse than the threshold.

11. The terminal apparatus according to claim 8, wherein in a case of the event-based reporting, the report configuration includes an event ID and a threshold, and
the event ID indicates a case in which a measurement result of a serving beam as a connecting beam becomes worse than the threshold.

12. The terminal apparatus according to claim 8, wherein the measurement report includes a measurement result of a serving beam as a connecting beam and/or a measurement result of a beam other than the serving beam.

13. The terminal apparatus according to claim 12, wherein a measurement result of the serving beam includes reception power or reception quality, and
a measurement result of a beam other than the serving beam includes a cell identity and a beam identity and reception power or reception quality.

14. The terminal apparatus according to claim 13, wherein the reception power or reception quality is calculated from a channel state information reference signal.

15. A communication method in a base station apparatus configured to communicate with a terminal apparatus, the method comprising the steps of:
transmitting a measurement configuration as configuration information of measurement performed by the terminal apparatus; and
receiving a measurement report from the terminal apparatus, wherein
the measurement configuration includes a report configuration, and a measuring beam list,
the report configuration includes a configuration indicating a periodic reporting or an event-based reporting, and
the measuring beam includes a cell identity and a beam identity.

16. A communication method in a terminal apparatus configured to communicate with a base station apparatus, the method comprising the steps of:
receiving a measurement configuration as configuration information of measurement from the base station apparatus; and
transmitting a measurement report to the base station apparatus, wherein
the measurement configuration includes a report configuration, and a measuring beam list,
the report configuration includes a configuration indicating a periodic reporting or an event-based reporting, and
the measuring beam includes a cell identity and a beam identity.
